(19) United States
(12) Patent Application Publication
(10) Pub. No.: US 2023/0064960 A1
(43) Pub. Date: Mar. 2, 2023

(54) FAUCET AND METHOD FOR CONTROLLING A FAUCET

(71) Applicant: Zhangzhou Solex Smart Home Co., Ltd., Zhangzhou City (CN)

(72) Inventors: Jianwen CHEN, Zhangzhou City (CN); Wenxing CHEN, Zhangzhou City (CN); Lihong HU, Zhangzhou City (CN)

(21) Appl. No.: 17/584,657

(22) Filed: Jan. 26, 2022

(30) Foreign Application Priority Data
Aug. 25, 2021 (CN) 202110981817.1

(51) Int. Cl. E03C 1/126; E03C 1/266; C02F 1/78

(52) U.S. Cl. CPC E03C 1/126; E03C 1/2665; C02F 1/78; C02F 2307/06; C02F 2303/04

(57) ABSTRACT

The present disclosure discloses a faucet. The faucet comprises a faucet device, a waste disposer, a first control mechanism, and a second control mechanism. The faucet device comprises a first water passage and a second water passage. The first control mechanism comprises a first control valve disposed on the first water passage and at least controlling a turning on and off of the first water passage. The second control mechanism comprises a control switch and a second control valve. The second control valve is disposed on the second water passage and at least controls a turning on and off of the second water passage. The second water passage is connected with an ozone supply device to enable the second water passage to supply ozonated water, and the control switch is controlled to generate a first instruction to turn on the second control valve and the waste disposer.

### RELATED APPLICATIONS

This application claims priority to Chinese patent application number 202110981817.1, filed on Aug. 25, 2021. Chinese patent application number 202110981817.1 is incorporated herein by reference.

### FIELD OF THE DISCLOSURE

The present disclosure relates to the field of kitchen and bathroom fixtures, and in particular relates to a faucet and method for controlling the faucet.

### BACKGROUND OF THE DISCLOSURE

The existing kitchen faucet with a function of processing food waste disclosed in Chinese patent CN111549861A comprises a housing, a dual control trigger element, a water supply control valve, a water valve control module, and a water valve communication module. The housing comprises a faucet notch corresponding to the faucet and a water outlet. The dual control trigger element is disposed on a housing wall of the housing. The water supply control valve is disposed in the housing, and the water supply control valve is connected between the faucet notch and the water outlet. The water valve control module is disposed in the housing, and the water valve control module is each electrically in communication with the dual control trigger element and the water supply control valve. The water valve communication module is disposed in the housing, and the water valve communication module is electrically in communication with the water valve control module, so that a conduction state of the water supply control valve and a grinding start of the kitchen garbage processor are triggered in response to a trigger signal generated by the dual control trigger element in an associated manner. It has the follow disadvantages. 1. There is a single waterway that supplies ordinary water and cooperates with a food waste disposer, and the single waterway does not have a function of disinfection and sterilization, so it is easy to breed bacteria for a long time, and the physical residue in the pipeline will create odors. 2. The dual control trigger element is easy to misuse.

### BRIEF SUMMARY OF THE DISCLOSURE

The present disclosure provides a faucet and a method for controlling a faucet to solve the deficiencies in the background.

In order to solve the technical problem, a first technical solution of the present disclosure is as follows.

A faucet comprises a faucet device, a waste disposer, a first control mechanism, and a second control mechanism. The faucet device comprises a first water passage and a second water passage. The first control mechanism comprises a first control valve disposed on the first water passage and at least controlling a turning on and off of the first water passage, and the second control mechanism comprises a control switch and a second control valve. The second control valve is disposed on the second water passage and at least controls a turning on and off of the second water passage, and the second water passage is connected with an ozone supply device to enable the second water passage to supply ozonated water. The control switch is controlled to generate a first instruction to turn on the second control valve and the waste disposer.

In a preferred embodiment, a position at which the ozone supply device is connected to the second water passage is located downstream of the second control valve.

In a preferred embodiment, the second control mechanism comprises a control unit connected to the control switch, and the control unit is connected to the second control valve and the waste disposer. The control unit receives the first instruction to control the second control valve and the waste disposer to be successively turned on.

In a preferred embodiment, the first water passage is disposed with a water flow sensor, and the control unit is in communication with the water flow sensor. When the water flow sensor obtains a water flowing signal indicating that water is flowing through the first water passage, the control unit controls at least one of the second control valve or the ozone supply device to be turned off.

In a preferred embodiment, the first control mechanism is disposed with a sensor, and the control unit is in communication with the sensor. When the sensor obtains a signal indicating that the first control mechanism is in an open state, the control unit controls at least one of the second control valve or the ozone supply device to be turned off.

In a preferred embodiment, the faucet comprises a water supply passage. The water supply passage comprises a cold water passage and a hot water passage, and the cold water passage is divided into a first divided water passage and a second divided water passage. The first water passage comprises a water mixing passage, the first divided water passage, and the hot water passage. The first control valve comprises a mixing valve, and the mixing valve is in communication with each of the first divided water passage, the hot water passage, and the water mixing passage. The second water passage comprises the second divided water passage.

In a preferred embodiment, the faucet comprises a control box. The second control valve, the ozone supply device, the control unit, and the water flow sensor are disposed in the control box, and the faucet device comprises a water outlet passage. The first water passage and the second water passage are each in communication with the water outlet passage, and junctions at which the water outlet passage is in communication with each of the first water passage and the second water passage are disposed in the control box.

In a preferred embodiment, the faucet comprises a water supply passage. The water supply passage comprises a cold water passage and a hot water passage, and the cold water passage is divided into a first divided water passage and a second divided water passage. The first water passage comprises a water mixing passage, the first divided water passage, and the hot water passage, and the first control valve comprises a mixing valve. The mixing valve is in communication with each of the first divided water passage, the hot water passage, and the water mixing passage, and the second water passage comprises the second divided water passage. A Venturi tube defining a Venturi water passage and a valve seat are fixedly disposed in the control box, and the valve seat comprises an entrance in communication with the cold water passage, a first divided water port, and a second divided water port. The first divided water port is in communication with the first divided water passage, and the second divided water port is disposed with the second control valve. The Venturi tube is connected to the valve seat, and the Venturi water passage is in communication with the second divided water port. The second divided water passage comprises the Venturi water passage, and the Venturi water passage comprises a mutation chamber having a radial dimension changing from small to large. The mutation chamber comprises a suction port in communication with the ozone supply device, and the Venturi tube is in communication with the water mixing passage located downstream of the Venturi water passage. The water outlet passage is connected to the Venturi tube.

In a preferred embodiment, the second water passage comprises a Venturi water passage, and the Venturi water passage comprises a mutation chamber having a radial dimension changing from small to large. The mutation chamber comprises a suction port in communication with the ozone supply device.

A second technical solution of the present disclosure is as follows.

A faucet comprises a faucet device, a waste disposer, and a control mechanism. The faucet device comprises a first water passage, a second water passage, a water supply passage, and the control mechanism comprises a switching valve. The switching valve is connected to each of the water supply passage, the first water passage, and the second water passage to enable the water supply passage to be alternatively in communication with the first water passage and the second water passage. The control mechanism comprises a control switch and a control unit connected to the control switch, and the control unit is connected to the switching valve and the waste disposer. The control switch is configured to be controlled to generate a first instruction, and the control unit is configured to control the switching valve to make the water supply passage be in communication with the second water passage and control the waste disposer to be turned on through the first instruction.

A third technical solution of the present disclosure is as follows.

A faucet comprises a faucet device, a waste disposer, a first control mechanism, and a second control mechanism. The faucet device comprises a first water passage and a second water passage, and the first control mechanism comprises a first control valve disposed on the first water passage and at least controlling a turning on and off of the first water passage. The second control mechanism comprises a control switch, a second control valve, and a control unit in electrical communication with the control switch, and the second control valve is disposed on the second water passage and at least controls a turning on and off of the second water passage. The second water passage is connected with an ozone supply device to enable the second water passage to supply ozonated water, and the first water passage is disposed with a water flow sensor configured to detect whether a water flow flows through the first water passage. The control unit is in communication with the water flow sensor, the second control valve, and the waste disposer.

A fourth technical solution of the present disclosure is as follows.

A faucet comprises a faucet device, a first control mechanism, and a second control mechanism. The faucet device comprises a first water passage and a second water passage, and the first control mechanism comprises a first control valve disposed on the first water passage and at least controlling a turning on and off of the first water passage. The second control mechanism comprises a control switch, a second control valve, and a control unit in electrical communication with the control switch, and the second control valve is disposed on the second water passage and at least controls a turning on and off of the second water passage. The second water passage is connected with an ozone supply device to enable the second water passage to supply ozonated water, and the control switch is configured to be controlled to generate a first instruction. The control unit is configured to receive the first instruction to control the second control valve to be turned on, and the control unit is configured to generate a driving signal that drives a waste disposer to be turned on after a predetermined time in which the second control valve is turned on.

A method for controlling a faucet comprises: 1) generating a first instruction by a control switch being controlled; 2) turning on a second control valve and an ozone supply device due to the first instruction being generated, supplying ozonated water by a second water passage, and turning on a waste disposer after a first predetermined time; 3) determining whether disposal of waste is complete; when the disposal of the waste is complete, turning off the waste disposer, and when the waste disposer has been turned off for a second predetermined time, turning off at least one of the second control valve or the ozone supply device; and 4) constantly determining whether a first water passage discharges water during the step 2 and the step 3; when the first water passage discharges water, turning off at least one of the second control valve or the ozone supply device.

The method for controlling the faucet comprises the following step: 5) receiving, by the second control valve and the ozone supply device, a second instruction, and turning on the second control valve and the ozone supply device to enable the second water passage to discharge the ozonated water; when the second control valve and the ozone supply device receive the second instruction again, turning off the second control valve and the ozone supply device, wherein the step 1 comprises: determining whether the control switch is controlled to generate the first instruction or the second instruction; when the first instruction is generated, execute the step 2; when the second instruction is generated, execute the step 5, and the step 4 comprises constantly determining whether the first water passage discharges water during the step 2, the step 3, and the step 5; when the first water passage discharges water, turning off at least one of the second control valve or the ozone supply device.

Compared with the existing techniques, the technical solution has the following advantages.

1. The faucet comprises the faucet device, the waste disposer, the first control mechanism, and the second control mechanism. The second control mechanism comprises the control switch and the second control valve, and the second control valve is disposed in the second water passage to at least control the turning ON and OFF of the second water passage. The second water passage is connected with the ozone supply device to supply the ozonated water. The control switch is controlled to generate the first instruction, and the first instruction is used to control the second control valve and the waste disposer to be open, so as to cleverly combine the ozonated water with the waste disposal. The waste disposer is used to process the waste, and the ozonated water is used for sterilization and disinfection. When the ozonated water is being supplied, the waste disposer is turned on, which is easy to use and can achieve further controlling.

2. The position at which the ozone supply device is connected to the second water passage is located downstream of the second control valve, which avoids the ozonated water flowing into the first water passage.

3. The second control valve, the ozone supply device, the control unit, and the water flow sensor are disposed in the control box, and junctions at which the water outlet passage is in communication with each of the first water passage and the second water passage are disposed in the control box, which has a simple structure and is convenient to install.

4. The Venturi tube defining the Venturi water passage and a valve seat are fixedly disposed in the control box, and the valve seat comprises the entrance in communication with the cold water passage, the first divided water port, and the second divided water port. The first divided water port is in communication with the first divided water passage, and the second divided water port is disposed with the second control valve. The Venturi tube is connected to the valve seat, and the Venturi water passage is in communication with the second divided water port. Therefore, the control box has a reasonable layout and a compact structure. The second divided water passage comprises the Venturi water passage, the Venturi water passage comprises the mutation chamber having a radial dimension significantly changing from small to large, and the mutation chamber comprises a suction port in communication with the ozone supply device. The negative pressure adsorption effect produced by the Venturi effect and the enhancement of oxygen intake combine to significantly mix the oxygen and the water flow to form the ozonated water. The Venturi tube is also in communication with the water mixing passage located downstream of the Venturi water passage, and the water outlet passage is connected to the Venturi tube, which is easy to install.

5. The faucet comprises the faucet device, the waste disposer, and the control mechanism. The control mechanism is connected to each of the switching valve and the waste disposer. The control mechanism is controlled by the control switch to generate the first instruction, and the first instruction is used to control the second control valve and the waste disposer to be open, so as to cleverly combine the ozonated water with the waste disposal. The waste disposer is used to process the waste, and the ozonated water is used for sterilization and disinfection. When the ozonated water is being supplied, the waste disposer is turned on, which is easy to use and can achieve further controlling.

6. The faucet comprises the faucet device, the waste disposer, the first control mechanism, and the second control mechanism. The faucet device comprises a first water passage and a second water passage, and the first control mechanism comprises a first control valve disposed on the first water passage and at least controlling a turning on and off of the first water passage. The second control mechanism comprises a control switch, a second control valve, and a control unit in electrical communication with the control switch, and the second control valve is disposed on the second water passage and at least controls a turning on and off of the second water passage. The second water passage is connected with an ozone supply device to enable the second water passage to supply ozonated water, the first water passage is disposed with a water flow sensor configured to detect whether a water flow flows through the first water passage, and the control unit is in communication with the water flow sensor, the second control valve, and the waste disposer. When the first water passage supplies water, the ozonated water is shut off for improving security.

### BRIEF DESCRIPTION OF THE DRAWINGS

FIG. 1 illustrates a schematic diagram of a faucet when the faucet only supplies ozonated water in the present disclosure.

FIG. 2 illustrates a schematic diagram of the faucet when a waste disposer processes waste in the present disclosure.

FIG. 3 illustrates a schematic diagram of the faucet when a first water passage supplies water in the present disclosure.

FIG. 4 illustrates a schematic diagram of a principle operation of the faucet, in which water flow directions are indicated by solid lines with arrows and control signals are indicated by dotted lines with arrows in the present disclosure.

FIG. 5 illustrates an exploded view of a faucet device in the present disclosure.

FIG. 6 illustrates an exploded view of a control box in the present disclosure.

FIG. 7 illustrates a perspective view of the control box in the present disclosure.

FIG. 8 illustrates a cross-sectional view of the control box in the present disclosure.

### DETAILED DESCRIPTION OF THE EMBODIMENTS

The present disclosure will be further described below in combination with the accompanying drawings and embodiments.

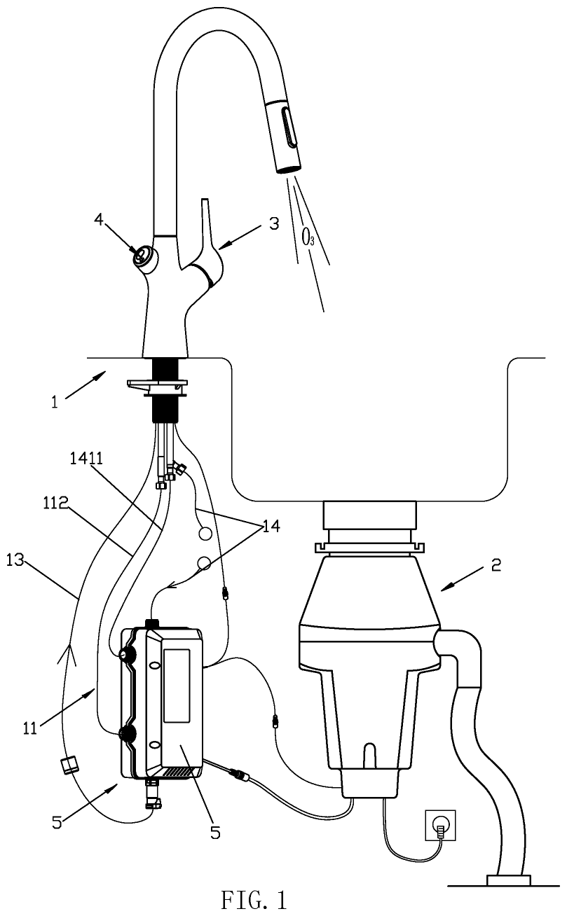

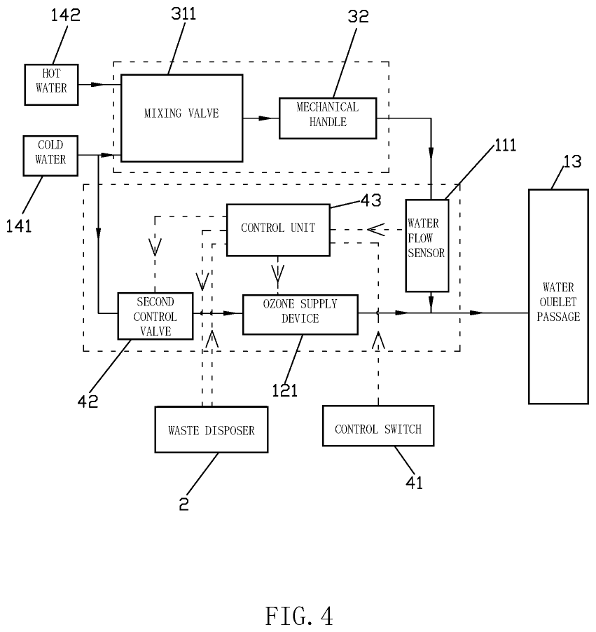

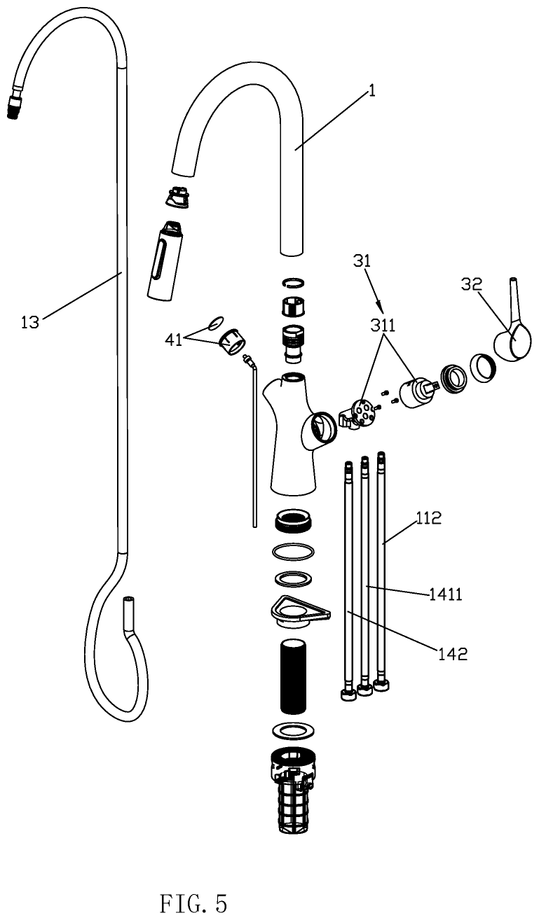

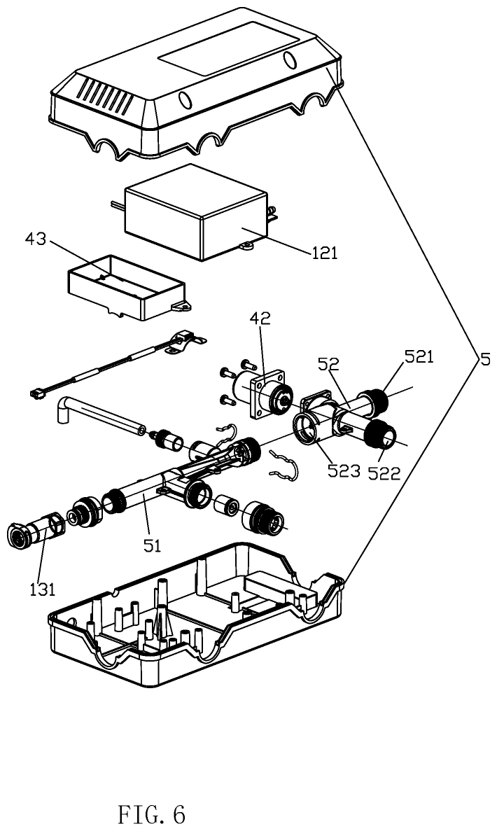

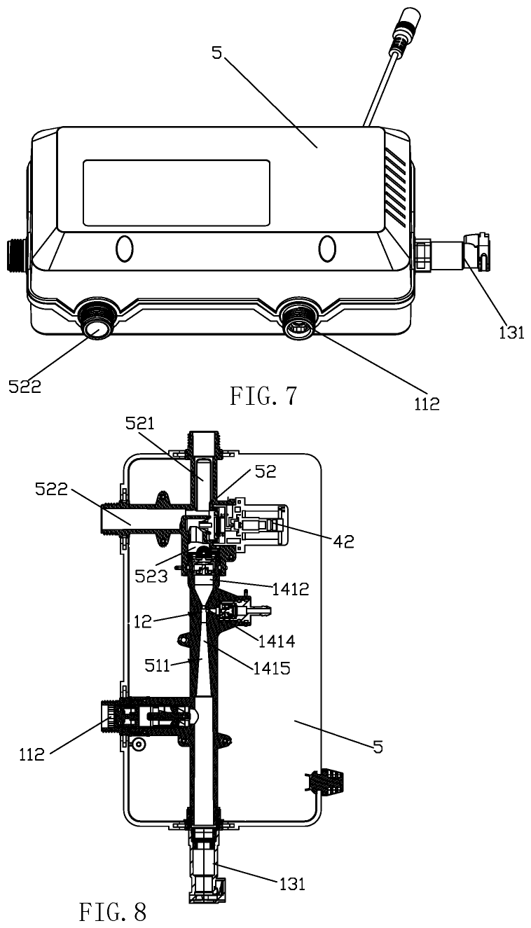

Referring to FIGS. 1-8, a kitchen faucet comprises a faucet device 1, a waste disposer 2, a first control mechanism 3, and a second control mechanism 4.

The faucet device 1 comprises a first water passage 11, a second water passage 12, and a water outlet passage 13. The first water passage 11 and the second water passage 12 are each in communication with the water outlet passage 13, and the first water passage 11 supplies ordinary water. The first control mechanism 3 comprises a first control valve 31 disposed on the first water passage 11 and controlling a turning ON and OFF of the first water passage 11 and a mechanical handle 32 operatively coupled to the first control valve 31 and driving the first control valve 31 to be changed to achieve the controlling. The first water passage 11 is disposed with a water flow sensor 111 configured to detect whether a water flow flows through the first water passage 11. The second control mechanism 4 comprises a control switch 41, a second control valve 42, and a control unit 43 in electrical communication with the control switch 41. The second control valve 42 is a solenoid valve, and the second control valve 42 is disposed on the second water passage 12 and controls a turning ON and OFF of the second water passage 12. The second water passage 12 is connected with an ozone supply device 121 to enable the second water passage 12 to supply ozonated water, and a position at which the ozone supply device 121 is connected to the second water passage 12 is located downstream of the second control valve 42. The control switch 41 is controlled to generate a first instruction and, the control switch 41 is a push button. The control unit 43 is connected to the second control valve 42, the waste disposer 2, the water flow sensor 111, and the ozone supply device 121, and the control unit 43 receives the first instruction to control the second control valve 42, the ozone supply device 121, and the waste disposer 2 to be successively turned on. When the water flow sensor 111 obtains a water flowing signal indicating that the water is flowing through the first water passage 11, the control unit 43 controls the second control valve 42 and the ozone supply device 121 to be turned off to ensure a priority of the first water passage 11 so as to avoid supplying the ozonated water when supplying the ordinary water. The faucet device 1 has the following advantages. 1. The ozonated water has strong oxidizing and sterilizing ability, can remove peculiar smells, increase the oxygen content of water, activate minerals, etc. The waste disposer 2 can treat waste and discharge the waste through a water flow, improving the performance of waste treatment in an environmental protection manner. The ozonated water and waste disposal are cleverly combined, the waste disposer 2 is used to dispose of the waste, and the ozonated water supplied by the faucet device 1 is used to disinfect the waste disposer 2. 2. The waste disposer 2 is automatically driven to be turned on after a predetermined time in which the ozone supply device 121 is turned on to supply the ozonated water, which is convenient for users and realizes one-step control. The water in advance can moisten the waste in a grinding cavity, thereby avoiding the excessive load of a motor of the waste disposer 2 to protect the waste disposer 2. 3. The grinding effect of the waste disposer 2 is improved. 4. The ozonated water is automatically shut off when the water flow is discharged from the first water passage 11, which improves the safety of use.

In this embodiment, the faucet further comprises a water supply passage 14. The water supply passage 14 comprises a cold water passage 141 and a hot water passage 142, and the cold water passage 141 is divided into a first divided water passage 1411 and a second divided water passage 1412. The first water passage 11 comprises a water mixing passage 112, the first divided water passage 1411, and the hot water passage 142. The first control valve 31 comprises a mixing valve 311, and the mixing valve 311 is in communication with each of the first divided water passage 1411, the hot water passage 142, and the water mixing passage 112 to be controlled by the mechanical handle 32 to be configured to control characteristics of the water (i.e., regulation of temperature, turning ON and OFF of the water, or regulation of flow). The first control valve 31 is similar to what is available in the prior art. The second water passage 12 comprises the second divided water passage 1412.

In this embodiment, the faucet further comprises a control box 5 in which the second control valve 42, the ozone supply device 121, the control unit 43, and the water flow sensor 111 are disposed. Junctions at which the water outlet passage 13 is in communication with each of the first water passage 11 and the second water passage 12 are disposed in the control box 5. A Venturi tube 51 defining a Venturi water passage 511 and a valve seat 52 are fixedly disposed in the control box 5, and the valve seat 52 comprises an entrance 521 in communication with the cold water passage 141, a first divided water port 522, and a second divided water port 523. The first divided water port 522 is in communication with the first divided water passage 1411, and the second divided water port 523 is disposed with the second control valve 42 to control a turning ON and OFF of water between the second divided water port 523 and the entrance 521. The Venturi tube 51 is connected to the valve seat 52, and the Venturi water passage 511 is in communication with the second divided water port 523. The second divided water passage 1412 comprises the Venturi water passage 511, and the Venturi water passage 511 comprises a mutation chamber 1415 having a radial dimension significantly varying from small to large. The mutation chamber 1415 comprises a suction port 1414 in communication with the ozone supply device 121. The Venturi tube 51 is also in communication with the water mixing passage 112 located downstream of the Venturi water passage 511, and the water outlet passage 13 is connected to the Venturi tube 51 through a joint 131.

In this embodiment, an alternating high-voltage electric field generated by the ozone supply device 121 makes oxygen-containing gas generate corona discharge, free high-energy electrons in the corona dissociate oxygen, and ozone gas is produced by collision reaction and polymerizing. When the ozone gas is transported into the Venturi tube 51, a high-speed water flowing in the Venturi tube 51 produces an adsorption effect so as to suck the ozone gas and dissolve the ozone gas in the water to generate the ozonated water.

A Method for Controlling the Faucet Comprises the Following Steps:

1) determining whether the control switch 41 is controlled to generate the first instruction or a second instruction. When the control switch 41 is pressed for a first duration of time, generating the first instruction and executing the step 2. When the control switch 41 is pressed for a second duration of time less than the first duration of time, generating the second instruction and executing the step 5;

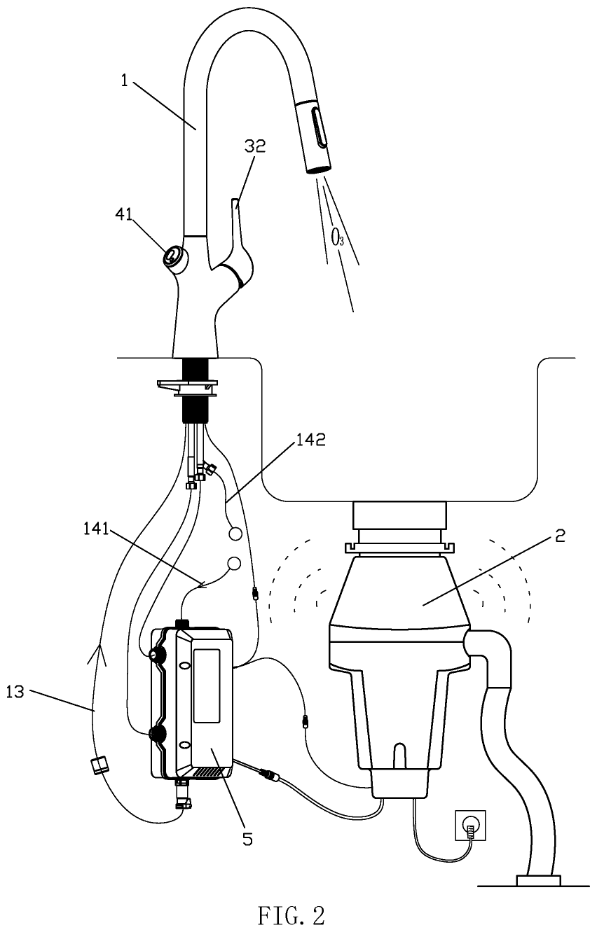

2) receiving the first instruction by the control unit 43, and turning on the second control valve 42 and the ozone supply device 121 to enable the second water passage 12 to be turned on. The water flow flowing through the mutation chamber 1415 generates a negative pressure to suck the ozone gas to form the ozonated water, the water outlet passage 13 discharges the ozonated water, and the waste disposer 2 is turned on after a first predetermined time (e.g., 5 seconds), as shown in FIG. 2;

3) determining, by the waste disposer 2, whether disposal of the waste is complete. When the disposal of the waste is complete, the waste disposer 2 is turned off. When the waste disposer 2 has been turned off for a second predetermined time (e.g., 5 seconds), at least one of the second control valve 42 or the ozone supply device 121 is turned off to shut off the ozonated water. The waste disposer 2 is similar to what is available in the prior art, and the waste disposer 2 comprises an alternating current motor and a blade disk driven by the alternating current motor. The blade disk grinds the food waste through a centrifugal force, the waste food ground by the blade disk is discharged into the sewer, and the waste disposer 2 determines whether disposal of the waste is complete through a load on the blade disk. When the blade disk is idling, the waste disposer 2 determines that the waste has been processed. When the waste disposer 2 is turned off, the ozonated water is shut off after the second predetermined time. The ozonated water flushes the treated waste into the sewer, and the sterilization and deodorization functions of the ozonated water are used to deeply clean the waste disposer 2 to prevent the physical residue in the pipeline from breeding pathogens and producing odor;

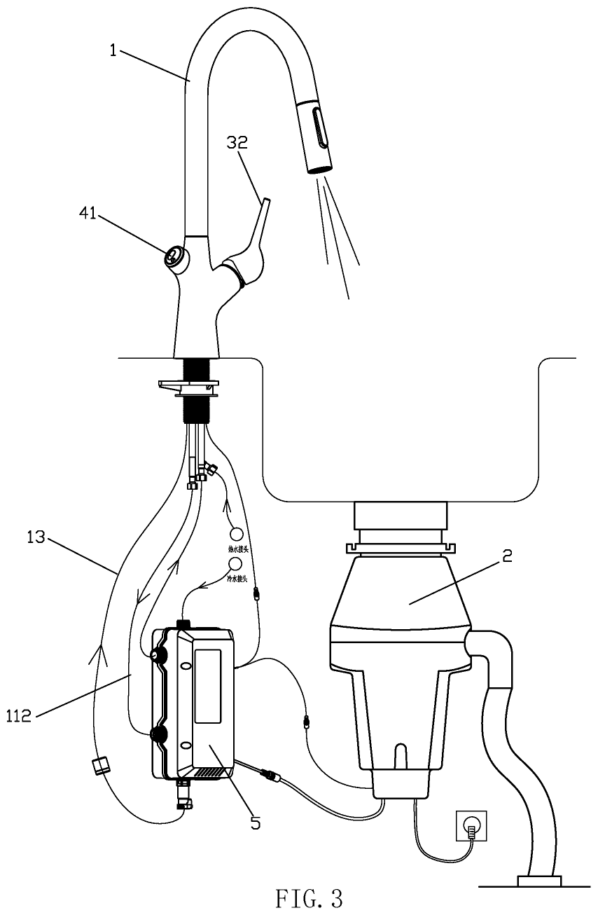

4) constantly determining whether the first water passage 11 discharges water during the step 2, 3, and 5. When the first water passage 11 discharges water, the second control valve 42 and the ozone supply device 121 are turned off, as shown in FIG. 3; and

5) receiving the second instruction by the second control valve 42 and the ozone supply device 121, and turning on the second control valve 42 and the ozone supply device 121 to discharge the ozonated water in the second water passage 12 and the water outlet passage 13. When the second control valve 42 and the ozone supply device 121 receive the second instruction again, the second control valve 42 and the ozone supply device 121 are turned off.

According to needs, the method for control the faucet further comprises the following step:

0) determining whether the first water passage 11 discharges water or the first control mechanism 3 is in an open state. When the first water passage 11 discharges water or the first control mechanism 3 is in an open state, the control switch 41 is turned off or the control switch 41 is invalidated.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A faucet, comprising:
a faucet device,
a waste disposer,
a first control mechanism, and
a second control mechanism, wherein:
the faucet device comprises a first water passage and a second water passage,
the first control mechanism comprises a first control valve disposed on the first water passage and at least controlling a turning on and off of the first water passage,
the second control mechanism comprises a control switch and a second control valve,
the second control valve is disposed on the second water passage and at least controls a turning on and off of the second water passage,
the second water passage is connected with an ozone supply device to enable the second water passage to supply ozonated water, and
the control switch is controlled to generate a first instruction to turn on the second control valve and the waste disposer.

2. The faucet according to claim 1, wherein:
a position at which the ozone supply device is connected to the second water passage is located downstream of the second control valve.

3. The faucet according to claim 1, wherein:
the second control mechanism comprises a control unit,
the control switch is connected to the control unit,
the control unit is connected to the second control valve and the waste disposer, and
the control unit receives the first instruction to control the second control valve and the waste disposer to be successively turned on.

4. The faucet according to claim 3, wherein:
the first water passage is disposed with a water flow sensor,
the control unit is in communication with the water flow sensor, and
when the water flow sensor obtains a water flowing signal indicating that water is flowing through the first water passage, the control unit controls at least one of the second control valve or the ozone supply device to be turned off.

5. The faucet according to claim 3, wherein:
the first control mechanism is disposed with a sensor,
the control unit is in communication with the sensor, and
when the sensor obtains a signal indicating that the first control mechanism is in an open state, the control unit controls at least one of the second control valve or the ozone supply device to be turned off.

6. The faucet according to claim 1, comprising:
a water supply passage, wherein:
the water supply passage comprises a cold water passage and a hot water passage,
the cold water passage is divided into a first divided water passage and a second divided water passage,
the first water passage comprises a water mixing passage, the first divided water passage, and the hot water passage,
the first control valve comprises a mixing valve,
the mixing valve is in communication with each of the first divided water passage, the hot water passage, and the water mixing passage, and
the second water passage comprises the second divided water passage.

7. The faucet according to claim 4, comprising:
a control box, wherein:
the second control valve, the ozone supply device, the control unit, and the water flow sensor are disposed in the control box,
the faucet device comprises a water outlet passage,
the first water passage and the second water passage are each in communication with the water outlet passage, and
junctions at which the water outlet passage is in communication with each of the first water passage and the second water passage are disposed in the control box.

8. The faucet according to claim 7, comprising:
a water supply passage, wherein:
the water supply passage comprises a cold water passage and a hot water passage,
the cold water passage is divided into a first divided water passage and a second divided water passage,
the first water passage comprises a water mixing passage, the first divided water passage, and the hot water passage,
the first control valve comprises a mixing valve,
the mixing valve is in communication with each of the first divided water passage, the hot water passage, and the water mixing passage,
the second water passage comprises the second divided water passage,
a Venturi tube defining a Venturi water passage and a valve seat are fixedly disposed in the control box,
the valve seat comprises an entrance in communication with the cold water passage, a first divided water port, and a second divided water port,
the first divided water port is in communication with the first divided water passage,
the second divided water port is disposed with the second control valve,
the Venturi tube is connected to the valve seat,
the Venturi water passage is in communication with the second divided water port,
the second divided water passage comprises the Venturi water passage,
the Venturi water passage comprises a mutation chamber having a radial dimension changing from small to large,
the mutation chamber comprises a suction port in communication with the ozone supply device,
the Venturi tube is in communication with the water mixing passage located downstream of the Venturi water passage, and
the water outlet passage is connected to the Venturi tube.

9. The faucet according to claim 1, wherein:
the second water passage comprises a Venturi water passage,
the Venturi water passage comprises a mutation chamber having a radial dimension changing from small to large, and
the mutation chamber comprises a suction port in communication with the ozone supply device.

10. A faucet, comprising:
a faucet device,
a waste disposer,
a first control mechanism, and
a second control mechanism, wherein:
the faucet device comprises a first water passage and a second water passage,
the first control mechanism comprises a first control valve disposed on the first water passage and at least controlling a turning on and off of the first water passage,
the second control mechanism comprises a control switch, a second control valve, and a control unit in electrical communication with the control switch,
the second control valve is disposed on the second water passage and at least controls a turning on and off of the second water passage,
the second water passage is connected with an ozone supply device to enable the second water passage to supply ozonated water,
the first water passage is disposed with a water flow sensor configured to detect whether a water flow flows through the first water passage, and
the control unit is in communication with the water flow sensor, the second control valve, and the waste disposer.

11. A method for controlling a faucet, comprising:
1) generating a first instruction by a control switch being controlled;
2) turning on a second control valve and an ozone supply device due to the first instruction being generated, supplying ozonated water by a second water passage, and turning on a waste disposer after a first predetermined time;
3) determining whether disposal of waste is complete; when the disposal of the waste is complete, turning off the waste disposer, and when the waste disposer has been turned off for a second predetermined time, turning off at least one of the second control valve or the ozone supply device; and
4) constantly determining whether a first water passage discharges water during the step 2 and the step 3; when the first water passage discharges water, turning off at least one of the second control valve or the ozone supply device.

12. The method for controlling the faucet of claim 11, comprising:
5) receiving, by the second control valve and the ozone supply device, a second instruction, and turning on the second control valve and the ozone supply device to enable the second water passage to discharge the ozonated water; when the second control valve and the ozone supply device receive the second instruction again, turning off the second control valve and the ozone supply device, wherein:
the step 1 comprises: determining whether the control switch is controlled to generate the first instruction or the second instruction; when the first instruction is generated, execute the step 2; when the second instruction is generated, execute the step 5, and
the step 4 comprises constantly determining whether the first water passage discharges water during the step 2, the step 3, and the step 5; when the first water passage discharges water, turning off at least one of the second control valve or the ozone supply device.
